(19) United States
(12) Patent Application Publication
(10) Pub. No.: US 2008/0231708 A1
(43) Pub. Date: Sep. 25, 2008

(54) Network apparatus, sound data transmission method, sound data transmission program, monitoring apparatus and security camera system

(75) Inventors: Shinichi Morimoto, Kanagawa (JP); Satoshi Okamoto, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/009,926

(22) Filed: Jan. 23, 2008

(30) Foreign Application Priority Data
Jan. 29, 2007 (JP) P2007-018130

(51) Int. Cl. H04N 7/18

(52) U.S. Cl. 348/159; 348/E07.085

(57) ABSTRACT

A network apparatus that sends sound data to another network apparatus connected over a network is disclosed. The network apparatus includes: a destination selecting part configured to select a predetermined number of network apparatuses as a destination network apparatus from network apparatuses connected to the network; and a sound data sending part configured to broadcast sound data to the predetermined number of the network apparatuses selected in the destination selecting part.

### CROSS REFERENCES TO RELATED APPLICATIONS

The present invention contains subject matter related to Japanese Patent Application JP 2007-018130 filed in the Japanese Patent Office on Jan. 29, 2007, the entire contents of which being incorporated herein by reference.

### BACKGROUND OF THE INVENTION

1. Field of the Invention

The present invention relates to a network apparatus, a sound data transmission method, a sound data transmission program, a monitoring apparatus, and a security camera system. More specifically, the invention relates to a network apparatus in which a predetermined number of network apparatuses connected to a network are selected as a destination, and sound data is sent to the predetermined number of the network apparatuses in broadcast transmission, and with this configuration, it is intended to reduce operator's operational efforts in sending sound data having the same descriptions to a given number of a plurality of network apparatuses.

2. Description of the Related Art

There is a technique as a security camera system in which a security camera (network camera) is connected to a monitoring apparatus (computer) over a network, a monitor image is imaged to obtain image data and the image data is sent from the security camera to the monitoring apparatus over the network (for example, see Patent Reference 1 (JP-A-2005-175758)).

Furthermore, in this type of security camera system, a security camera has a sound output function in which sound data is sent from a monitoring apparatus (monitoring center) to the security camera side over a network (for example, see Patent Reference 2 (JP-A-2006-185127)).

### SUMMARY OF THE INVENTION

Heretofore, in sending sound data having the same descriptions to a plurality of security cameras connected to a monitoring apparatus over a network, for example, an operator manually enters an IP address (Internet Protocol Address) to secure the connection to the security camera for sending the sound data in one to one communications, and the operator repeats this operation by the number of the security cameras. In this case, the more increased the number of the security cameras as a destination is, the more grows the operator's operational efforts. In addition, in this case, the security camera operated in later transmission operation receives the sound data at a more delayed reception time instant. Thus, in the case in which it is necessary to make an urgent warning by speech, for example, such delays might cause troubles.

It is thus desirable to intend a reduction in operator's operational efforts in sending sound data having the same descriptions to a given number of a plurality of network apparatuses.

An embodiment of the invention is a security camera system including a security camera connected to a monitoring apparatus over a network, wherein the security camera has: a sound data receiving part configured to receive sound data sent from the monitoring apparatus; and a sound output part configured to output sounds configured of sound data received in the sound data receiving part, and the monitoring apparatus has: a destination selecting means for selecting a predetermined number of the security cameras as a destination from security cameras connected to the network; and a sound data sending part that broadcasts sound data to the predetermined number of the security cameras selected in the destination selecting means.

In the embodiment of the invention, a monitoring apparatus (a network apparatus) is connected to a security camera (another network apparatus) over a network. In the monitoring apparatus, in sending sound data having the same descriptions to a predetermined number of security cameras, a predetermined number of security cameras are selected as a destination from the security cameras connected to the network, and the sound data is broadcast to the predetermined number of the selected security cameras. In the security camera to which the sound data is sent, the sound data is received, and sounds configured of the received sound data are outputted.

Broadcast transmission is performed, whereby it is unnecessary for an operator to repeat the operation of sending sound data in one to one communications after the connection to the security camera is secured by the number of the security cameras, which leads to a reduction in operator's operational efforts. In addition, broadcast transmission is performed, whereby it is eliminated that the reception time instant of sound data is delayed in a security camera even though there are a number of destination security cameras.

For example, in the embodiment of the invention, security cameras connected to the network may be automatically detected. In this case, an operator can select a destination security camera among them, and can omit efforts of manual input of the IP address of the destination security camera in selecting a security camera.

For example, in the embodiment of the invention, a group can be registered that is configured of a predetermined number of given security cameras selected from the security cameras connected to the network, in which when an operator selects a predetermined number of security cameras as destination security cameras, a predetermined group registered in advance may be selected. In this case, a plurality of patterns of groups is registered in advance, whereby an operator can quickly switch groups of the destination security cameras depending on the situations.

For example, in the embodiment of the invention, broadcast transmission may be performed in accordance with a scheme described below. More specifically, sound data from a sound source device such as a microphone is temporarily arranged in a shared memory. Then, after that, a predetermined number of sending units (processes) extract the sound data from the shared memory, and sends the data to a security camera corresponding thereto. In this case, each of the sending units extracts the sound data arranged in the shared memory, and sends the data to the security camera assigned thereto. Thus, even though it is difficult to make access to a plurality of sound source devices at the same time, broadcast transmission to a predetermined number of security cameras can be performed excellently.

According to the embodiment of the invention, a predetermined number of network apparatuses connected to a network are selected as a destination, and sound data is broadcast to the predetermined number of the network apparatuses, which can reduce operator's operational efforts for sending sound data having the same descriptions to a given number of a plurality of network apparatuses.

### BRIEF DESCRIPTION OF THE DRAWINGS

FIG. 1 shows a block diagram depicting the configuration of a security camera system as an embodiment;

FIG. 2 shows a block diagram depicting an exemplary configuration of a security camera;

FIG. 3 shows a flow chart depicting the sound processing operation of the security camera;

FIG. 4 shows a functional block diagram depicting an exemplary configuration of a monitoring apparatus;

FIG. 5 shows a diagram depicting an exemplary GUI screen right after activated in the case in which a sound transmission tool is activated in the monitoring apparatus;

FIG. 6 shows a sequence diagram depicting the process steps of automatic detection of security cameras with voice directions connected to a network;

FIG. 7 shows a diagram depicting an exemplary GUI screen after the automatic detection of the security cameras in the case in which the sound transmission tool is activated in the monitoring apparatus;

FIG. 8 shows a diagram depicting an exemplary GUI screen when an “Add” button is pressed down in the case in which the sound transmission tool is activated in the monitoring apparatus;

FIG. 9 shows a diagram depicting an exemplary GUI screen for sound upload operation in the case in which the sound transmission tool is activated in the monitoring apparatus;

FIG. 10 shows a block diagram depicting an exemplary specific configuration of a sound data sending part that broadcasts sound data to n cameras of selected security cameras (n is an integer of one or greater);

FIG. 11 shows a sequence diagram depicting the process steps of the sound data sending part that broadcasts sound data to a predetermined number of security cameras;

FIG. 12 shows a flow chart depicting an exemplary control operation of broadcast transmission done by a control part of the monitoring apparatus;

FIG. 13 shows a flow chart depicting an exemplary control operation done by the control part of the monitoring apparatus in the registration of a group;

FIG. 14 shows a flow chart depicting an exemplary control operation done by the control part of the monitoring apparatus in the deletion of a group; and

FIG. 15 shows a flow chart depicting another exemplary control operation of broadcast transmission done by the control part of the monitoring apparatus.

### DETAILED DESCRIPTION OF THE INVENTION

Hereinafter, an embodiment of the invention will be described with reference to the drawings.

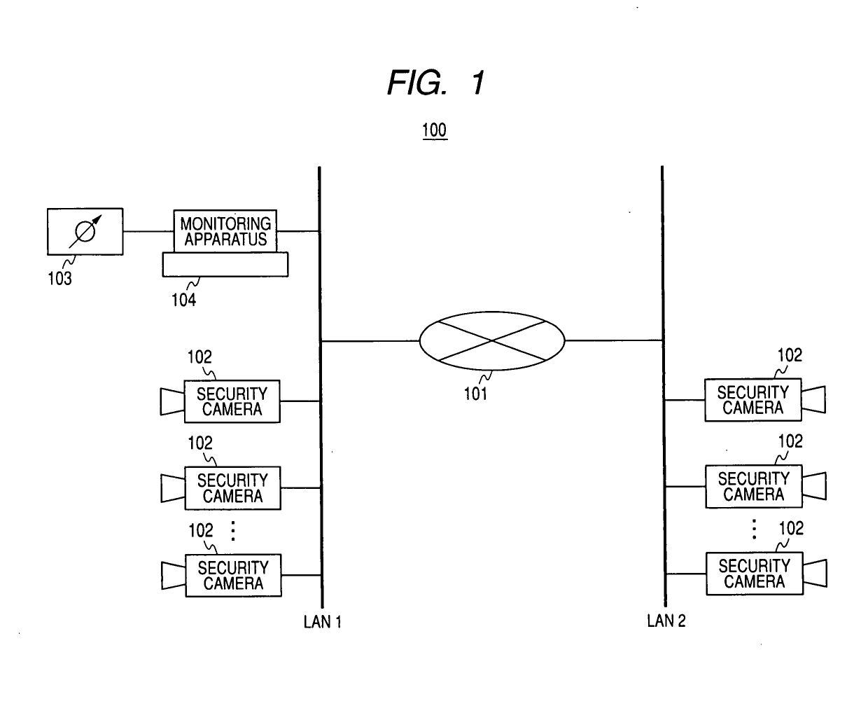

FIG. 1 shows the configuration of a security camera system 100 as an embodiment. In the security camera system 100, a local area network LAN 1 is connected to a local area network LAN 2 over the Internet 101. The local area network LAN 1 is configured of a plurality of security cameras 102 and a single monitoring apparatus 104. In addition, the local area network LAN 1 is configured of a plurality of security cameras 102.

As described later, each of the security cameras 102 has a sound output function that includes a speaker, for example, as a component. The monitoring apparatus 104 is configured of a personal computer having a sound transmission function. To the monitoring apparatus 104, a microphone 103 as a sound source device is connected.

The security camera 102 images a monitor image, generates image data corresponding to the monitor image, and then sends the image data to the monitoring apparatus 104. In addition, the security camera 102 has a function of detecting a moving object or an unmoving object in which the security camera 102 generates metadata including information about the detected moving object or unmoving object, and sends the metadata to the monitoring apparatus 104. Moreover, the security camera 102 receives sound data sent from the monitoring apparatus 104, and outputs sounds configured of the sound data.

The monitoring apparatus 104 stores image data and metadata sent from the security camera 102 in a storage, and displays an image configured of the image data on a monitor. In addition, the monitoring apparatus 104 broadcasts sound data obtained through the microphone 103 to a predetermined number of the security cameras 102 selected by an operator.

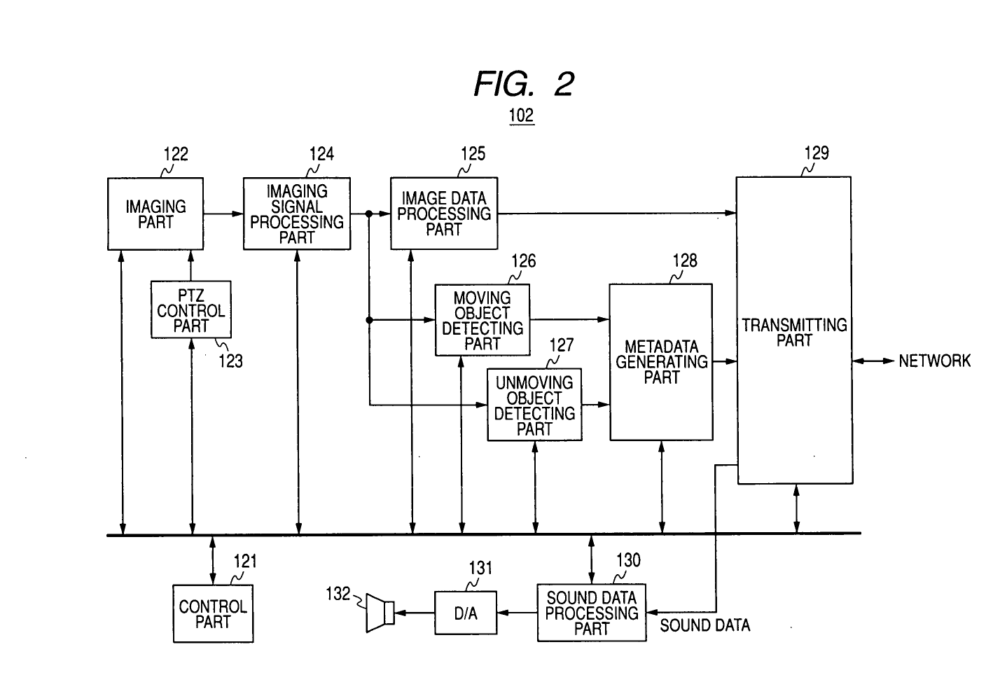

An exemplary configuration of the security camera 102 will be described with reference to a block diagram shown in FIG. 2.

In FIG. 2, the security camera 102 has a control part 121, an imaging part 122, a PTZ control part 123, an imaging signal processing part 124, an image data processing part 125, a moving object detecting part 126, an unmoving object detecting part 127, a metadata generating part 128, a transmitting part 129, a sound data processing part 130, a D/A converter 131, and a speaker 132.

The control part 121 controls the operations of the individual parts of the security camera 102. For example, the control part 121 has a CPU (Central Processing Unit), a ROM (Read Only Memory), and a RAM (Random Access Memory). In this case, the CPU reads a control program stored in the ROM as necessary, forwards the read control program to the RAM and decompresses it, and reads and executes the decompressed control program to control the operations of the individual parts.

The imaging part 122 has a lens and an imaging device, not shown, which images a monitor image, and outputs imaging signals corresponding to the monitor image. The imaging device is an imaging device such as a CCD (Charged Coupled Device) or a CMOS (Complementary Metal-Oxide Semiconductor). Furthermore, the imaging part 122 has a pan/tilt/zoom function (PTZ function). The PTZ control part 123 controls a pan position, a tilt position, and a zooming factor in the imaging part 122 under control done by the control part 121.

The imaging signal processing part 124 subjects imaging signals (analog signals) outputted from the imaging part 122 to sample hold and gain control, conversion from analog signals into digital signals, white balance adjustment, and gamma correction, and then generates image data. The imaging part 122 and the imaging signal processing part 124 configure an image data generating part. The image data processing part 125 subjects the image data generated in the imaging signal processing part 124 to data compression process, and generates compressed image data.

The moving object detecting part 126 processes the image data generated in the imaging signal processing part 124 to detect a moving object area from an image configured of the image data. The unmoving object detecting part 127 processes the image data generated in the imaging signal processing part 124 to detect an unmoving object area (an area in which an object appears, and an area in which an object disappears) from an image configured of the image data. The operation of detecting a moving object in the moving object detecting part 126 is performed in the case in which the detection of a moving object is selected. Similarly, the operation of detecting an unmoving object in the unmoving object detecting part 127 is performed in the case in which the detection of an unmoving object is selected.

The metadata generating part 128 generates metadata including information about the moving object detected in the moving object detecting part 126 or unmoving object detected in the unmoving object detecting part 127. For example, metadata includes information about the number of moving objects (unmoving objects), and the position and size of each of moving objects (unmoving objects). In addition, in the case in which a moving object is detected, motion level information about each of the detected areas is also included.

The transmitting part 129 sends the compressed image data generated in the image data processing part 125 and the metadata generated in the metadata generating part 128 to the monitoring apparatus 104 over the network in accordance with protocols such as FTP (File Transfer Protocol), and HTTP (Hypertext Transfer Protocol).

In addition, the transmitting part 129 receives control signals sent from the monitoring apparatus 104 over the network, and supplies the signals to the control part 121. The control part 121 controls the operations of the individual parts based on the control signals. For example, in adjusting the camera position (the pan position and the tilt position) or the zooming factor on the monitoring apparatus 104 side, the monitoring apparatus 104 sends the control signals that control these parameters. In addition, for example, in setting (changing) the detection condition for a moving object or an unmoving object on the monitoring apparatus 104 side, the monitoring apparatus 104 sends control signals (detection setting signals) corresponding to the set detection conditions.

In addition, the transmitting part 129 receives sound data compressed and encoded, the data sent from the monitoring apparatus 104 over the network, and supplies the data to the sound data processing part 130.

The sound data processing part 130 decodes the sound data supplied from the transmitting part 129. The D/A converter 131 converts the sound data supplied from the sound data processing part 130 from digital signals into analog signals, and supplies the signals to the speaker 132. The speaker 132 outputs sounds configured of the supplied sound data.

The operation of the security camera 102 shown in FIG. 2 will be described. An imaging signal corresponding to the monitor image (the analog signal) is obtained from the imaging part 122. The imaging signal is supplied to the imaging signal processing part 124. In the imaging signal processing part 124, the imaging signal is subjected to analog signal processing such as sample hold and gain control, A/D conversion process, and digital signal processing such as white balance adjustment and gamma correction, and then image data is generated. The image data is supplied to the image data processing part 125. In the image data processing part 125, the image data is subjected to the data compression process to generate compressed image data. The compressed image data is supplied to the transmitting part 129.

In addition, the image data generated in the imaging signal processing part 124 is supplied to the moving object detecting part 126 and the unmoving object detecting part 127. In the moving object detecting part 126, in the case in which it is selected to detect a moving object, based on the detection conditions such as a detection frame and a non-detection frame, the image data is processed to detect a moving object area. In addition, in the moving object detecting part 126, the motion level is detected in each of the detection frames. Information about the moving object area and the motion level detected in the moving object detecting part 126 is supplied to the metadata generating part 128.

On the other hand, in the unmoving object detecting part 127, in the case in which it is selected to detect an unmoving object, based on the detection conditions such as a detection frame and a non-detection frame, the image data is processed to detect an unmoving object area. Information about the unmoving object area thus detected in the unmoving object detecting part 127 is supplied to the metadata generating part 128.

In the metadata generating part 128, metadata including information about the moving object detected in the moving object detecting part 126 or unmoving object detected in the unmoving object detecting part 127 is generated. For example, metadata includes information about the number of the detected moving objects (the unmoving objects), the position and size of each of the detected moving objects (the unmoving objects), and the motion level of each of the detected areas. In addition, for example, metadata also includes information about the pan position, the tilt position, and the zooming factor. The metadata generated in the metadata generating part 128 as discussed above is supplied to the transmitting part 129.

In the transmitting part 129, the compressed image data generated in the image data processing part 125 and the metadata generated in the metadata generating part 128 are sent to the monitoring apparatus 104 over the network in accordance with protocols such as FTP and HTTP. In addition, the transmitting part 129 receives the control signal sent from the monitoring apparatus 104 over the network.

The control signal received in the transmitting part 129 is supplied to the control part 121. The control signal includes the control signal for controlling the pan position, the tilt position and the zooming factor, or the control signal (the detection setting signal) corresponding to the detection conditions for the moving object detecting part 126 and the unmoving object detecting part 127.

For example, when the detection setting signal is supplied, the control part 121 controls the operations of the moving object detecting part 126 and the unmoving object detecting part 127 to allow the moving object detecting part 126 and the unmoving object detecting part 127 to operate under the set detection conditions. In addition, for example, when the control signal for the camera position (the pan position and the tilt position) or the zooming factor, the control part 121 controls the PTZ control part 123 to adjust the camera position (the pan position and the tilt position) or the zooming factor.

In addition, the transmitting part 129 receives sound data sent from the monitoring apparatus 104 over the network. The sound data (compressed and encoded data) is supplied to the sound data processing part 130. The sound data processing part 130 subjects the sound data (compressed and encoded data) to decoding process, and supplies the sound data after processed to the speaker 132 through the D/A converter 131. Thus, the speaker 132 outputs sounds configured of the sound data (for example, warning sounds) sent from the monitoring apparatus 104.

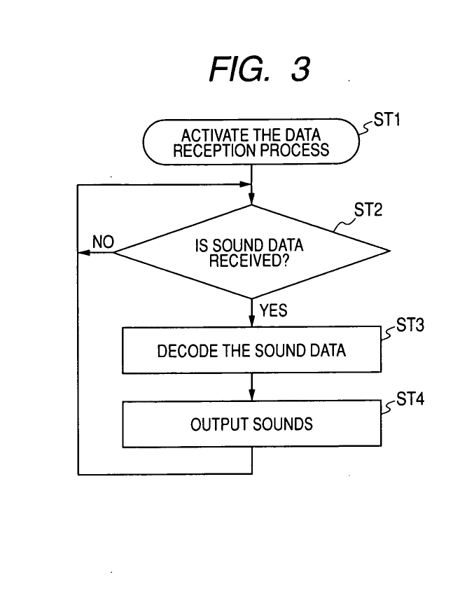

A flowchart shown in FIG. 3 depicts the sound processing operation done by the control part 121 of the security camera 102.

First, in Step ST1, the control part 121 activates the data reception process for the sound data, and after that, the control part 121 goes to Step ST2. In Step ST2, the control part 121 determines whether sound data is received. If sound data is received, in Step ST3, the control part 121 decodes the sound data in the sound data processing part 130. After that, in Step ST4, the control part 121 outputs the decoded sound data from the sound data processing part 130, supplies the data to the speaker 132 through the D/A converter 131, and then outputs sounds. After the process in Step ST4, the control part 121 returns to Step ST2, and repeatedly performs the process steps similar to those described above.

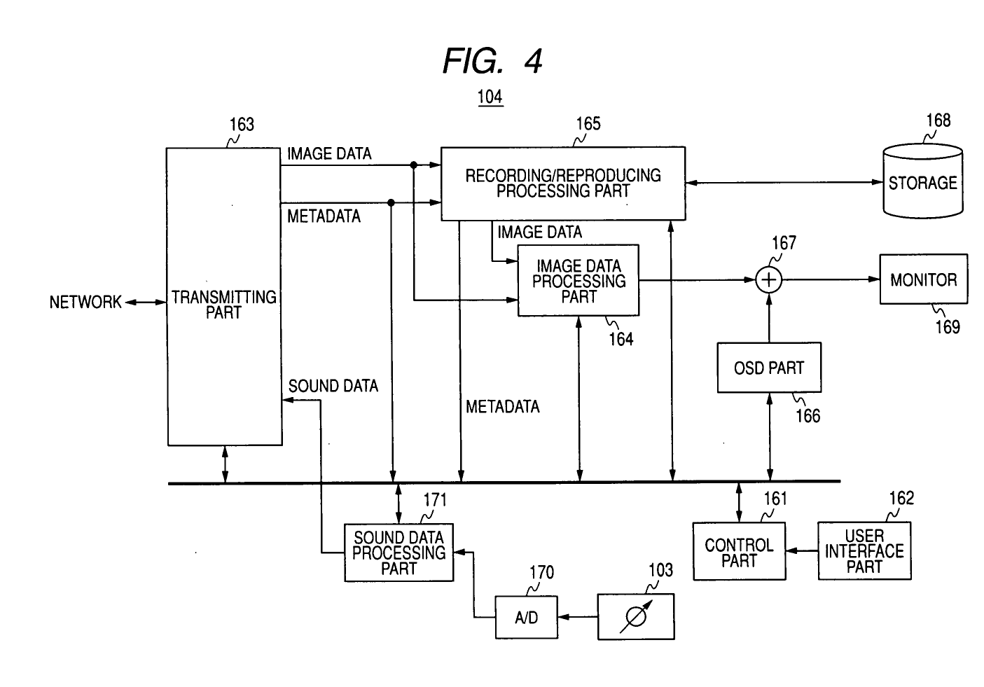

Next, an exemplary configuration of the monitoring apparatus 104 will be described with reference to the functional blocks shown in FIG. 4.

In FIG. 4, the monitoring apparatus 104 has a control part 161, a user interface part 162, a transmitting part 163, an image data processing part 164, a recording/reproducing processing part 165, an on-screen display (OSD) part 166, a synthesizing part 167, a storage 168, a monitor 169, an A/D converter 170, and a sound data processing part 171.

The control part 161 controls the operations of the individual parts of the monitoring apparatus 104. The control part 161 is configured of a CPU. The CPU reads a control program stored in the ROM as necessary, forwards the read control program to the RAM and decompresses the program, and reads and executes the decompressed control program to control the operations of the individual parts. The user interface part 162 is configured of operation keys and a remote control signal receiver, for example. The user interface part 162 is connected to the control part 161. The user interface part 162 generates operation signals corresponding to user manipulations, and supplies the signals to the control part 161.

The transmitting part 163 receives image data (compressed image data) and metadata sent from the security camera 102 over the network. In addition, the transmitting part 163 broadcasts the sound data obtained through the microphone 103 to a predetermined number of the security cameras 102 selected by an operator.

In addition, the transmitting part 163 sends control signals outputted from the control part 161 for controlling the security camera 102 to the security camera 102 over the network in accordance with protocols such as FTP. Insetting the detection conditions for the moving object detecting part 126 and the unmoving object detecting part 127 of the security camera 102, the control part 161 outputs the control signals (detection setting signals) corresponding to the detection conditions for the moving object detecting part 126 and the unmoving object detecting part 127 in response to user's setting manipulation. In adjusting the camera position (the pan position and the tilt position) or the zooming factor of the security camera 102, the control part 161 outputs the control signal for the adjustment.

The storage 168 records the image data (the compressed image data) and metadata received in the transmitting part 163. For example, the storage 168 is configured of a hard disk drive (HDD). The recording/reproducing processing part 165 controls recording image data and metadata on the storage 168 and controls reproducing image data and metadata from the storage 168.

The image data processing part 164 subjects the image data (the compressed image data) received in the transmitting part, or the image data (the compressed image data) reproduced from the storage 168 to a data decompression process, and generates image data for output. The image data processing part 164 generally subjects image data received in the transmitting part 163 to the data decompression process, but in reproduction, the image data processing part 164 subjects the image data reproduced from the storage 168 to the data decompression process.

The OSD part 166 generates a display signal for OSD based on control done by the control part 161. For example, the OSD part 166 generates a display signal for a GUI (Graphical User Interface) screen to be provided for an operator in sending the sound data obtained through the microphone 103 to the security camera 102. As described later, the operator uses the GUI screen to select a destination security camera 102 and to upload sound data.

The synthesizing part 167 combines the image data obtained in the image data processing part 164 with the display signal outputted from the OSD part 166, and supplies the combined signal to the monitor 169. In this case, on the monitor 169, an image configured of the image data obtained in the image data processing part 164 is displayed as well as OSD display is performed in accordance with the display signal outputted from the OSD part 166.

The A/D converter 170 converts the sound data outputted from the microphone 103 from analog signals into digital signals. The sound data processing part 171 compresses and encodes the sound data converted into the digital signals in the A/D converter 170, and generates sound data (compressed sound data) for transmission. The sound data processing part 171 configures an encoder for compression and encoding.

The operation of the monitoring apparatus 104 shown in FIG. 4 will be described. The transmitting part 163 receives image data (compressed image data) and metadata sent from the security camera 102. The image data is supplied to the recording/reproducing processing part 165 and the image data processing part 164. On the other hand, the metadata is supplied to the recording/reproducing processing part 165 and the control part 161. In the case in which recording is instructed by an operator setting, the recording/reproducing processing part 165 records the image data and the metadata on the storage 168.

The image data processing part 164 subjects the image data supplied from the transmitting part 163 to the data decompression process to generate image data for output. In addition, the control part 161 controls the OSD part 166 based on the metadata supplied from the transmitting part 163, and allows the OSD part 166 to generate display signals for showing information about the moving object or the unmoving object.

The synthesizing part 167 combines the image data obtained in the image data processing part 164 with the display signals supplied from the OSD part 166, and supplies the combined signals to the monitor 169. Thus, on the monitor 169, an image corresponding to the monitor image imaged in the security camera 102 is displayed. Then, for example, on that image, information about the detected moving object or unmoving object is shown in OSD display.

In addition, in reproducing the image data and the metadata from the storage 168, the reproduced image data is supplied to the image data processing part 164 through the recording/reproducing processing part 165, and the reproduced metadata is supplied to the control part 161 through the recording/reproducing processing part 165. Then, as similar to the operations done to the image data and the metadata received in the transmitting part 163, an image configured of the reproduced image data is displayed on the monitor 169 as well as information about a moving object or an unmoving object is shown on the image in OSD display.

In addition, in controlling the security camera 102, the control part 161 outputs a control signal for controlling the security camera 102, and the control signal is supplied to the transmitting part 163. The control signal is sent from the transmitting part 163 to the security camera 102 over the network. For the control signal to be sent from the monitoring apparatus 104 to the security camera 102, for example, there are control signals for controlling the camera position (the pan position and the tilt position) or the zooming factor, and control signals (detection setting signals) corresponding to the detection conditions for the moving object detecting part 126 and the unmoving object detecting part 127.

In sending the sound data to the security camera 102, the sound data obtained through the microphone 103 is supplied to the sound data processing part 171 through the A/D converter 170. The sound data processing part 171 compresses and encodes the sound data. The sound data (the compressed sound data) from the sound data processing part 171 is supplied to the transmitting part 163. Then, the transmitting part 163 broadcasts the sound data to a predetermined number of the security cameras 102 selected by the operator.

The sound data transmission process in the monitoring apparatus 104 will be further described. In the case in which sound data is sent from the monitoring apparatus 104 to the security camera 102, it is necessary for the operator to select a predetermined number of security cameras 102 as a destination.

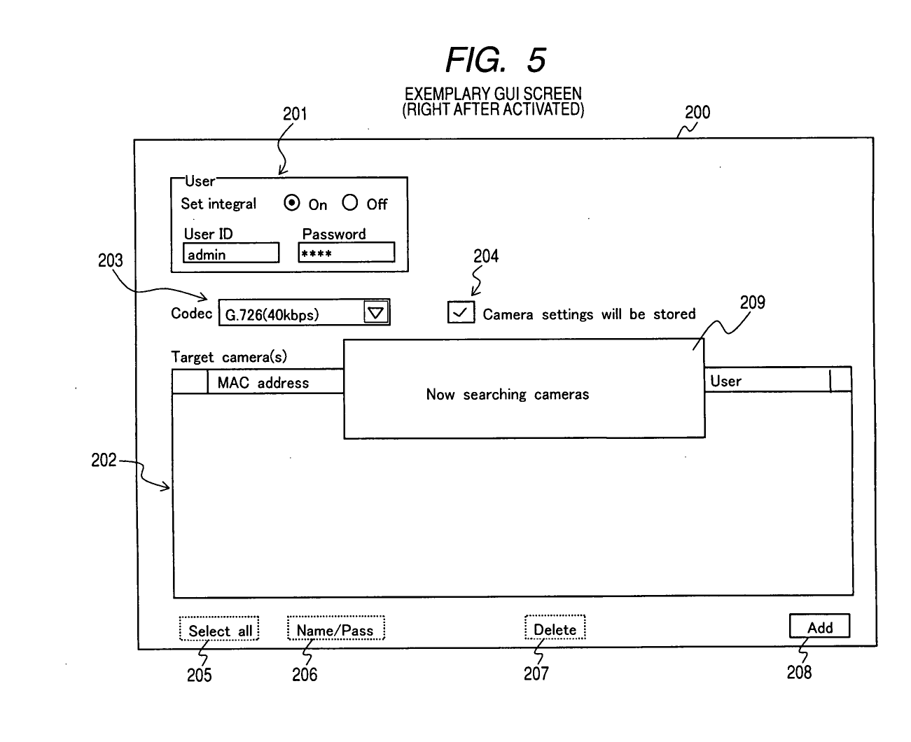

In the embodiment, in the monitoring apparatus 104, a sound transmission tool is activated for sending sound data, and then a GUI screen 200 that selects a predetermined number of security cameras 102 as a destination is displayed on the monitor 169. FIG. 5 shows an exemplary GUI screen 200 right after activated.

The GUI screen 200 has a user section 201. An indication “Set integral” in the user section 201 is turned on, and then the input sections “User ID” and “Password” are allowed for use. As user information “User” (“User ID” and “Password”) about all the security cameras displayed in a target camera section 202, described later, an input value is displayed. On the other hand, the indication “Set integral” in the user section 201 is turned off, and then the input sections “User ID” and “Password” are not allowed for use. As the user information “User” (“User ID” and “Password”) about each of the security cameras displayed in the target camera section 202, described later, the value stored as information about each of the cameras is displayed. The GUI screen 200 shown in FIG. 5 is an example in which the indication “Set integral” is turned on.

In addition, the GUI screen 200 has a codec section 203 that sets a scheme for compression and encoding of sound data. In the codec section 203, the operator can select a predetermined compression and encoding scheme from a plurality of compression and encoding schemes. In addition, the GUI screen 200 has a check section 204 for an indication “Camera setting will be stored”. The check section 204 is marked to take over the current settings when activated next time.

Moreover, the GUI screen 200 has a target camera section 202. In the target camera section 202, security cameras 102 possibly selected as a destination for sound data are displayed. In this case, actually, a MAC address (MAC address), an IP address (IP address), a model name (MODEL), a serial number (Serial), and user information (User) of each of the security cameras 102 are displayed.

In addition, the GUI screen 200 has a “Selectall” button 205, a “Name/Pass” button 206, a “Delete” button 207, and an “Add” button 208. The “Select all” button 205 is pressed down to turn into the state in which all the security cameras 102 displayed in the target camera section 202 are selected. Moreover, in order to separately select the security cameras 102 displayed in the target camera section 202, it is sufficient that the check section provided as corresponding to the security camera 102 is marked. In the case in which none of the security cameras 102 are displayed in the target camera section 202, the “Select all” button 205 is not allowed to be pressed.

The “Name/Pass” button 206 is pressed down to change user information “User” (“User ID” and “Password”) of the security camera 102 being selected in the target camera section 202. In the case in which none of the security cameras 102 are displayed in the target camera section 202, and in the case in which the indication “Set integral” in the user section 201 is turned on, the “Name/Pass” button 206 is not allowed to be pressed.

The “Delete” button 207 is pressed down to delete the security camera 102 being selected in the target camera section 202. In the case in which none of the security cameras 102 are displayed in the target camera section 202, the “Delete” button 207 is not allowed to be pressed. The %“Add” button 208 is pressed down to register (list) the security camera 102 by manual input. The security camera 102 thus registered is additionally displayed in the target camera section 202.

The GUI screen 200 shown in FIG. 5 is a screen right after activated, and in the target camera section 202, none of the security cameras 102 are displayed. Therefore, the “Select all” button 205, the “Name/Pass” button 206 and the “Delete” button 207 are not allowed to be pressed down (depicted by a broken line frame).

In the embodiment, the sound transmission tool is activated, and then the security cameras 102 connected to the network can be detected automatically. Then, the detected security cameras 102 are displayed in the target camera section 202 on the GUI screen 200. A dialog box 209 on the GUI screen 200 shown in FIG. 5 indicates that the security cameras 102 are now searching. Moreover, the dialog box 209 is modal dialog, and the other manipulations are inhibited until the dialog box 209 is closed, that is, until the detection process for the security camera 102 is finished.

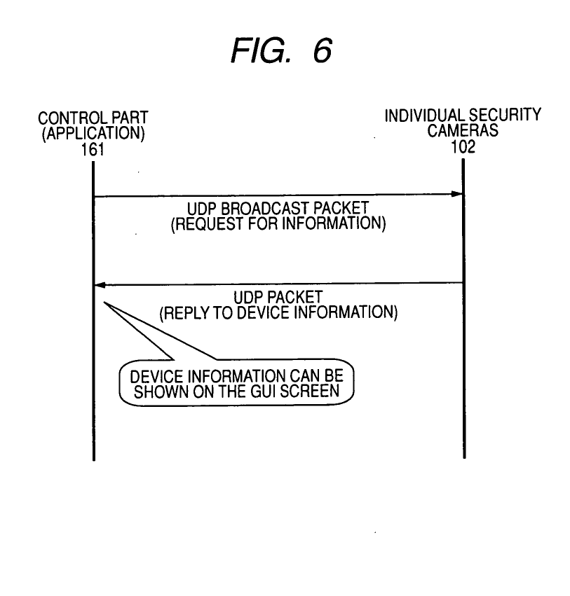

The automatic detection of the security cameras 102 connected to the network is done in accordance with the process steps in a sequence diagram shown in FIG. 6. More specifically, the control part (an application on the computer) 161 of the monitoring apparatus 104 sends a UDP (User Datagram Protocol) broadcast packet to the network, and requests all the security cameras 102 in the same network segment to send a reply packet. In response to the request, each of the security cameras 102 sends back a UDP packet as a reply packet to the control part 161 of the monitoring apparatus 104. The UDP packet includes device information (the MAC address, the IP address, the model name and so on). The control part 161 analyzes the UDP packet sent back from each of the security cameras 102 to detect the security cameras 102 in the same network segment and to display the security cameras 102 in the target camera section 202 on the GUI screen 200.

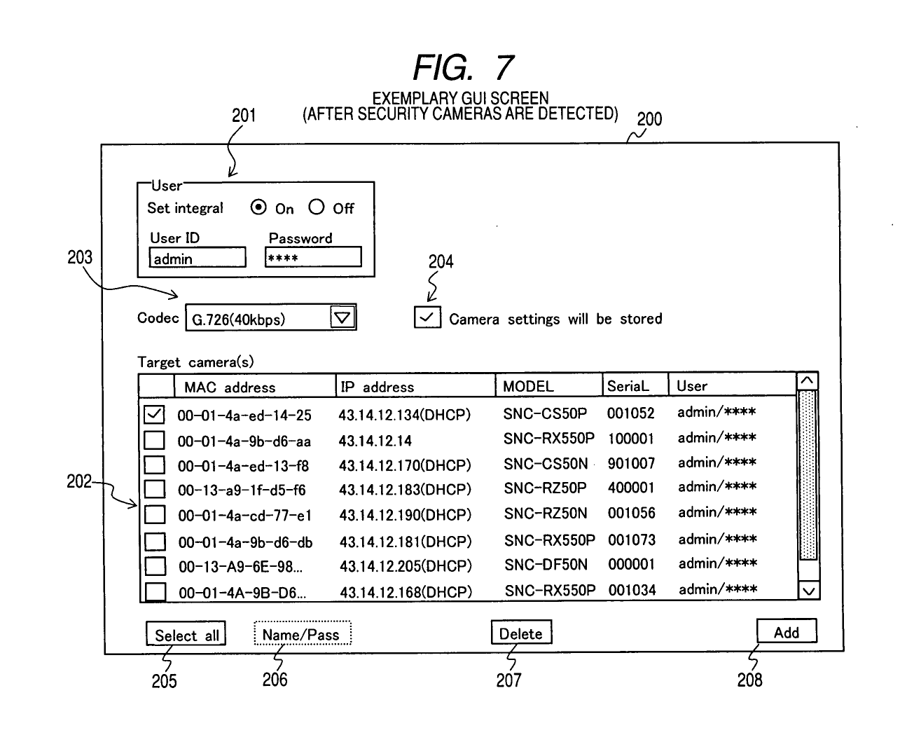

FIG. 7 shows an exemplary GUI screen 200 after the automatic detection of the security camera 102. In the target camera section 202 on the GUI screen 200, the detected security cameras 102 are displayed. In this case, the “Select all” button 205 and the “Delete” button 207 are allowed to be pressed down (indicated by a solid line frame).

Moreover, in the automatic detection of the security cameras 102, targets are only the security cameras 102 in the same network segment (LAN 1) as the monitoring apparatus 104 belongs thereto. In other words, in the automatic detection of the security cameras 102, for example, the security cameras 102 in the other network segments connected to the Internet 101 are not targeted.

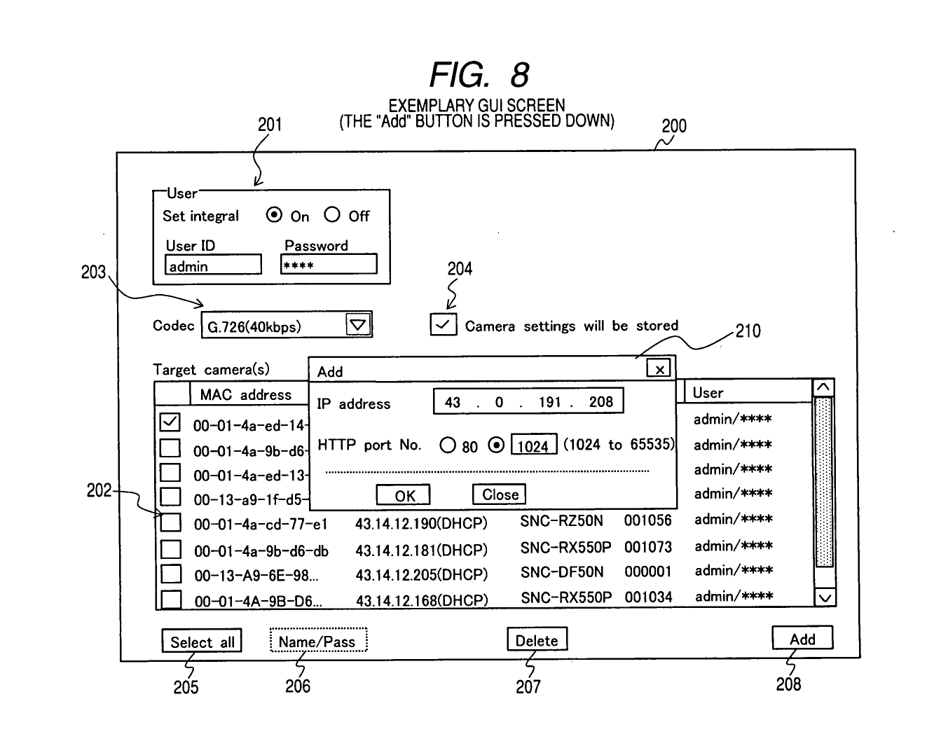

The “Add” button 208 provided on the GUI screen 200 is used to register (list) the security cameras 102 connected to the Internet 101. FIG. 8 shows an exemplary GUI screen 200 in the case in which the “Add” button 208 is pressed down. On the GUI screen 200, a dialog box 210 to register the security cameras 102 is displayed. The operator enters an IP address and a HTTP port number on the dialog box 210 to register a given security camera 102 and to display the camera 102 in the target camera section 202.

In selecting a predetermined number of the security cameras 102 as a destination, the operator selects a predetermined number of the security cameras 102 from the target camera section 202 on the GUI screen 200. In this case, in the case in which all the cameras 102 are selected, it is sufficient to press the “Select all” button 205 down, and in the case in which the cameras 102 are selected separately, it is sufficient to mark the corresponding check section.

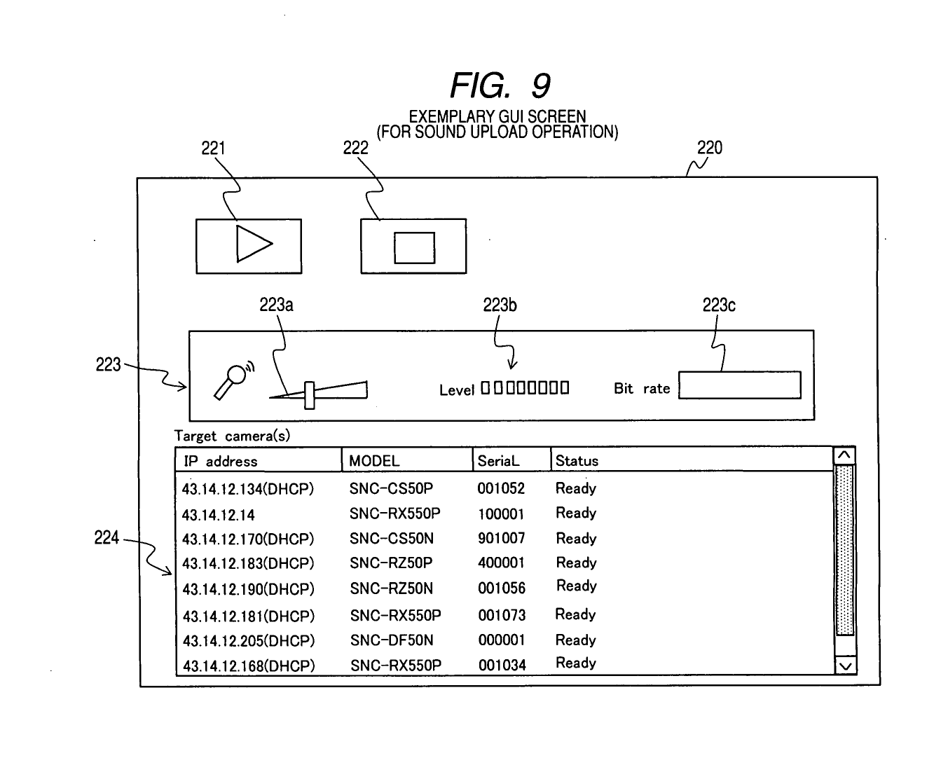

As described above, the operator selects sound upload in the state in which a predetermined number of the security cameras 102 are selected as a destination, and then a GUI screen 220 for sound upload operation is displayed on the monitor 169 as shown in FIG. 9. Moreover, sound upload is selected by the operator to choice a tag for selecting sound upload, but the tag for selecting is omitted for the simplicity of the drawing.

The GUI screen 220 has a transmission start button 221 and a transmission end button 222. The transmission start button 221 is pressed down to start uploading sounds, that is, sound data is broadcast from the microphone 103 to a predetermined number of the selected security cameras 102. In addition, the transmission end button 222 is pressed down to finish sound upload.

At the time when sound data upload is started, the sound data processing part 171 compresses and encodes sound data obtained through the microphone 103, the sound data being converted into digital signals and supplied from the A/D converter 170, and sound data (compressed and encoded data) for transmission is generated. Then, the sound data for transmission is supplied to the transmitting part 163, and broadcast to a plurality of the selected security cameras 102.

In addition, the GUI screen 220 has a transmission state indicator section 223. The transmission state indicator section 223 has a slide bar 223a that sets the volume level of the microphone 103, a volume level indicator 223b that indicates the level (volume) of the sound data outputted from the microphone 103, and a bit rate indicator 223c that indicates the bit rate of sending sound data.

In addition, the GUI screen 220 has a target camera section 224. In the target camera section 224, a predetermined number of the security cameras 102 selected as a destination by operator's manipulation are displayed. In broadcast transmission, a connection is established to a predetermined number of the selected security cameras 102, and then sound data is transmitted. In the GUI screen 220 shown in FIG. 9, any connection is not established to each of the security cameras 102 yet, and an indication “Status” is an indication “Ready” indicating standby. Although it is not shown, the indication “Status” is turned to an indication “Sending” indicating that sound data is being sent when a connection is established to actually send the sound data.

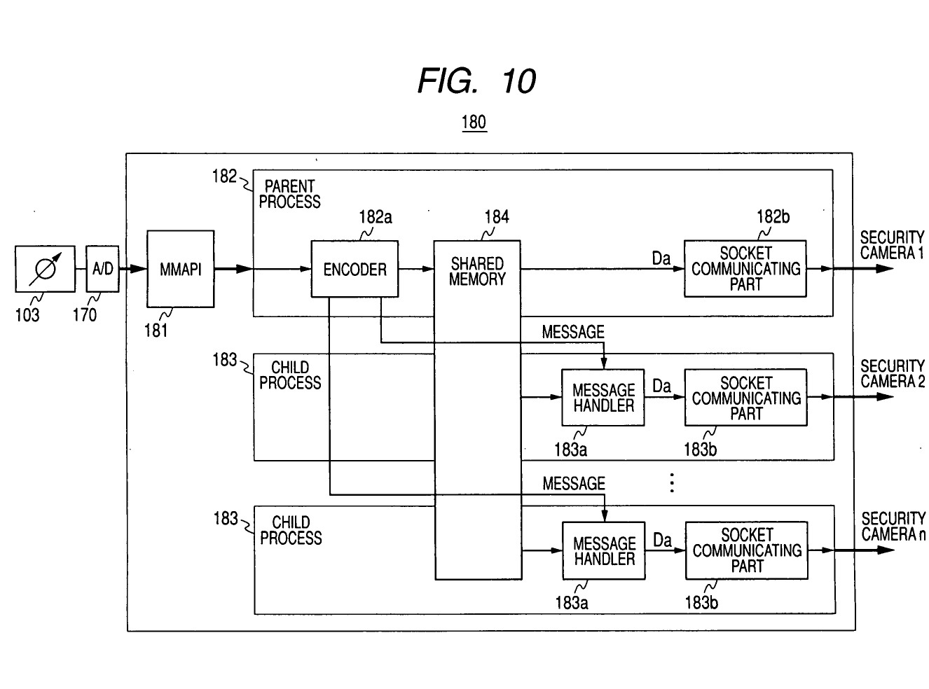

FIG. 10 shows a specific exemplary configuration of a sound data sending part 180 that broadcasts sound data to n cameras of selected security cameras 102 (n is an integer of one or greater). The sound data sending part 180 is implemented by an application owned by the monitoring apparatus 104 (personal computer), which corresponds to part of the sound data processing part 171 and the transmitting part 163 in the functional blocks of the monitoring apparatus 104 shown in FIG. 4.

The sound data sending part 180 has a multimedia system API (Application Program Interface) 181, a parent process 182, n−1 processes of child processes 183, and a shared memory 184. For example, the multimedia system API 181 is provided on Windows (trademark). To a tool relating to sounds in the multimedia system API 181, a right to open the microphone system is exclusively provided.

The parent process 182 is an application that is first activated, and configures a sending unit that sends sound data to a security camera 1. The parent process 182 has an encoder 182a and a socket communicating part 182b. In the parent process 182, sound data obtained through the microphone 103 is acquired through the multimedia system API 181, the sound data is compressed and encoded in the encoder 182a, and after that, the compressed and encoded data is arranged in the shared memory 184. In addition, in the parent process 182, sound data Da is extracted from the shared memory 184, and the sound data Da is sent to the security camera 1 in TCP connection through the socket communicating part 182b.

n−1 processes of child processes 183 are activated after the parent process 182 is started, which configure a sending unit that sends sound data to a security camera 2 to a security camera n. The child process 183 has a message handler 183a and a socket communicating part 183b. In the child process 183, when the encoder 182a of the parent process 182 notifies the message handler 183a of message data that sound data is arranged in the shared memory 184, the sound data Da is extracted from the shared memory 184, and the sound data Da is sent to the security camera having TCP connection established and assigned to the child process 183 through the socket communicating part 183b.

As described above, in the sound data sending part 180 shown in FIG. 10, the parent process 182 is configured in which sound data obtained through the microphone 103 is acquired, compressed, encoded and then arranged in the shared memory 184, each of a predetermined number of the processes (the parent process 182 and the child processes 183) corresponding to a predetermined number of the selected security cameras (the security camera 1 to the security camera n) as a destination extracts the sound data Da from the shared memory 184, and each of the processes sends the sound data Da to the security camera assigned thereto. As discussed above, even though the right to open the microphone system is exclusively provided in the sounds relating tool of the multimedia system API 181, the broadcast transmission of sound data to a predetermined number of security cameras 102 can be implemented excellently.

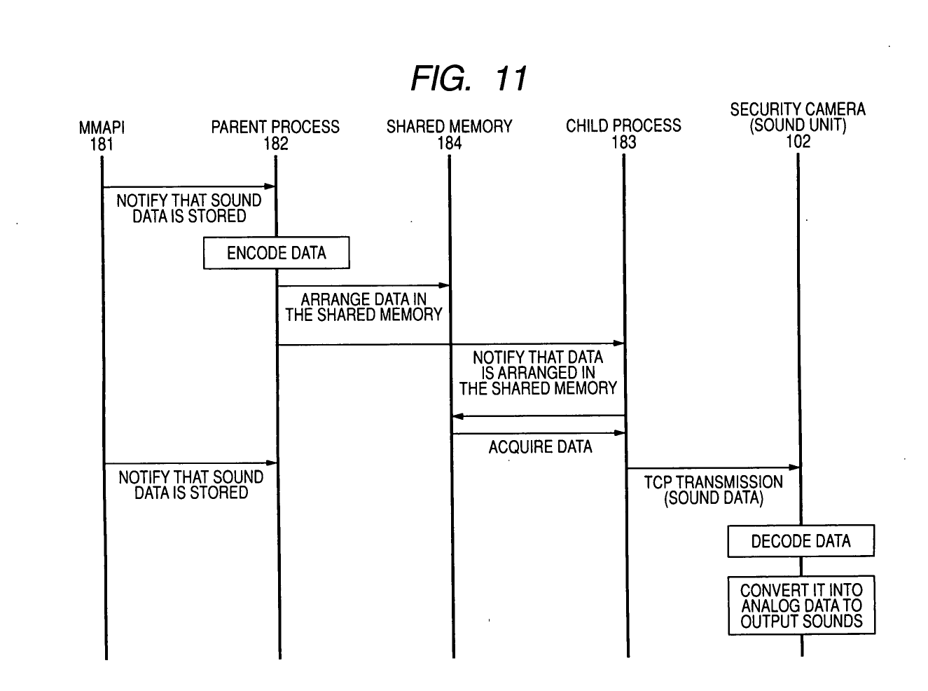

FIG. 11 shows a sequence diagram depicting the process steps of the sound data sending part 180.

First, the multimedia API 181, to which sound data obtained through the microphone 103 is supplied, notifies the parent process 182 that a certain volume of sound data is stored. In response to the reception of this notification, the parent process 182 acquires the certain volume of sound data from the multimedia API 181, and compresses and encodes the data in the encoder 182. After that, the parent process 182 arranges the compressed and encoded sound data in the shared memory 184 as well as notifies the message handler 183a of the child process 183 of a message that the sound data is arranged in the shared memory 184.

The child process 183 having been notified of the message makes access to the shared memory 184, and extracts the sound data, and sends the sound data to the security camera 102 assigned thereto in TCP transmission. Moreover, the security camera 102 having received the sound data decodes the sound data, converts the decoded sound data into analog signals, and supplies the data to the speaker 132 for output of sounds.

A series of the process steps is repeatedly performed at every time when a certain volume of sound data obtained through the microphone 103 is supplied to the multimedia API 181.

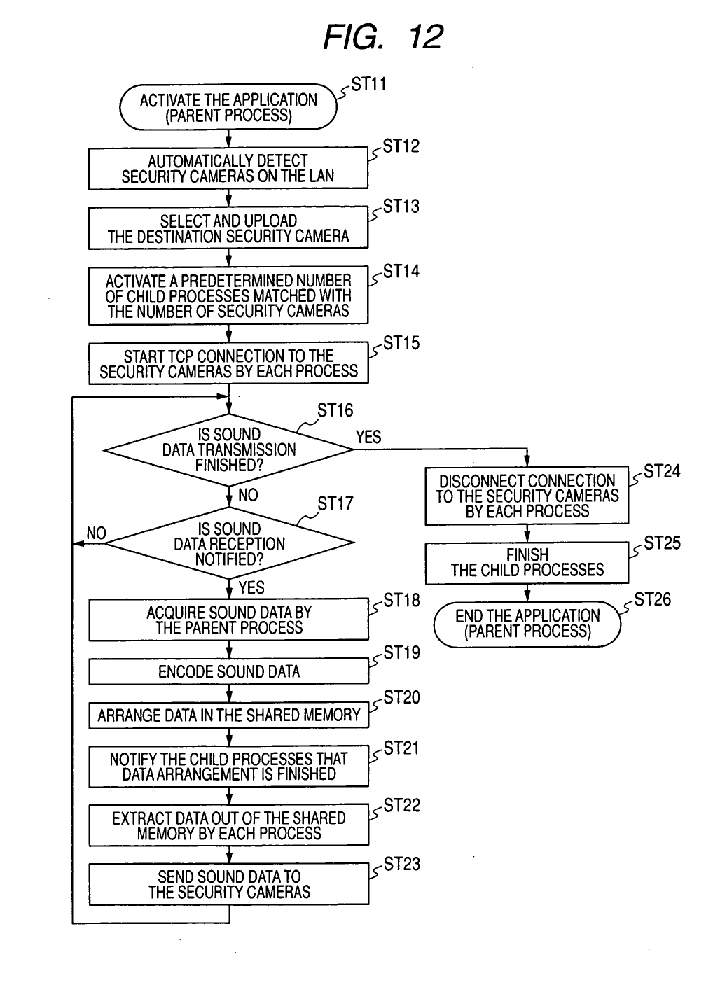

FIG. 12 shows a flow chart depicting the control operation of broadcast transmission done by the control part 161 of the monitoring apparatus 104.

First, in Step ST11, the control part 161 activates the application (the parent process 182), and goes to Step ST12. In Step ST12, the control part 161 automatically detects security cameras 102 on the LAN (within the same network segment) to which the monitoring apparatus 104 is connected. Moreover, in Step ST12, an operator additionally registers a security camera 102 on the Internet 101 as a candidate destination as necessary (see FIG. 8).

Then, in Step ST13, when the operator selects and uploads a destination security camera 102, in Step ST14, the control part 161 activates the child process 183 in the number matched with the number of the security cameras 102 selected as a destination. In this case, when the number of the selected security cameras 102 is n cameras, the control part 161 activates (n−1) processes of the child processes 183 (see FIG. 10).

Subsequently, in Step ST15, the control part 161 performs control in such a way that each of the processes (the parent process 182 and the child processes 183) starts establishing TCP connection to the security camera 102 assigned thereto. Then, in Step ST16, the control part 161 determines whether sound data transmission is finished. The control part 161 determines that sound data transmission is finished when the operator presses down the transmission end button 222 on the GUI screen 220 (see FIG. 9). If the control part 161 determines that sound data transmission is not finished, the control part 161 goes to Step ST17.

In Step ST17, the control part 161 determines whether the multimedia API 181 notifies the parent process 182 (the encoder 182a) that a certain volume of sound data is stored. If no notification is made, the control part 161 returns to Step ST16. On the other hand, if the notification is made, in Step ST18, the control part 161 performs control in such a way that the parent process 182 acquires a certain volume of sound data from the multimedia API 181. Then, in Step ST19, the control part 161 allows the encoder 182a of the parent process 182 to compress and encode the sound data, and in Step ST20, the control part 161 controls the encoder 182a of the parent process 182 to arrange the compressed and encoded sound data in the shared memory 184.

Subsequently, in Step ST21, the control part 161 controls the encoder 182a of the parent process 182 to notify the message handler 183a of the child process 183 of a message that it is completed to arrange data. Then, in Step ST22, the control part 161 controls each of the processes (the parent process 182 and the child process 183) to extract sound data from the shared memory 184. Furthermore, in Step ST23, the control part 161 controls each of the processes to send the sound data to the security camera 102 assigned thereto. After the process in Step ST23, the control part 161 returns to Step ST16, and goes to the control operation for a subsequent certain volume of sound data.

In addition, if the control part 161 determines that the sound data transmission is finished in Step ST16, the control part 161 goes to Step ST24. In Step ST24, the control part 161 controls each of the processes to disconnect the connection to the security camera 102. Then, in Step ST25, the control part 161 finishes the child process 183, and after that, in Step ST26, the control part 161 finishes the application (the parent process 182).

As described above, in the security camera system 100 shown in FIG. 1, the monitoring apparatus 104 can select a predetermined number of security cameras 102 connected to the network as a destination, and broadcast sound data to the predetermined number of the security cameras 102. Thus, it can be intended to reduce operator's operational efforts for sending sound data having the same descriptions to a given number of a plurality of security cameras 102. In other words, broadcast transmission is performed, whereby it is unnecessary for the operator to repeat the operation of sending sound data in one to one communications after the connection to the security camera 102 is secured by the number of the security cameras 102, which reduces operator's operational efforts. In addition, broadcast transmission is performed, whereby variations in the time instant at which sound data is sent are reduced, and a delay in the reception time instant of sound data is eliminated even though there are a number of destination security cameras 102.

In addition, in the security camera system 100 shown in FIG. 1, the monitoring apparatus 104 can automatically detect the security cameras 102 in the same network segment, and the operator can select a destination security camera 102 among them (see FIG. 7), which leads to an omission of efforts of manual input of the IP address of a destination security camera in selecting a security camera.

In addition, in the security camera system 100 shown in FIG. 1, the sound data sending part 180 of the monitoring apparatus 104 (see FIG. 10) has the scheme in which the parent process 182 acquires, compresses and encodes sound data obtained through the microphone 103, and then arranges the data in the shared memory 184, and a predetermined number of processes (the parent process 182 and the child processes 183) matched with a predetermined number of the selected security cameras (the security camera 1 to the security camera n) as a destination each extract sound data Da from the shared memory 184 and send the data to the security camera assigned thereto separately. As described above, even though the right to open the microphone system is exclusively provided in the sounds relating tool of the multimedia system API 181, the broadcast transmission of sound data to a predetermined number of security cameras 102 can be performed excellently.

Moreover, in the embodiment, it is described that the operator selects a predetermined number of security cameras 102 as a destination from the security cameras 102 shown in the target camera section 202 displayed on the GUI screen 200 (see FIG. 7) on the monitoring apparatus 104 side. However, for example, such a scheme may be possible in which on the monitoring apparatus 104 side, an operator uses the GUI screen 200 like this to register a predetermined number of groups formed of given security cameras 102 in advance, and the operator selects a predetermined number of the groups in making a choice of a predetermined number of security cameras 102 as destination security cameras 102.

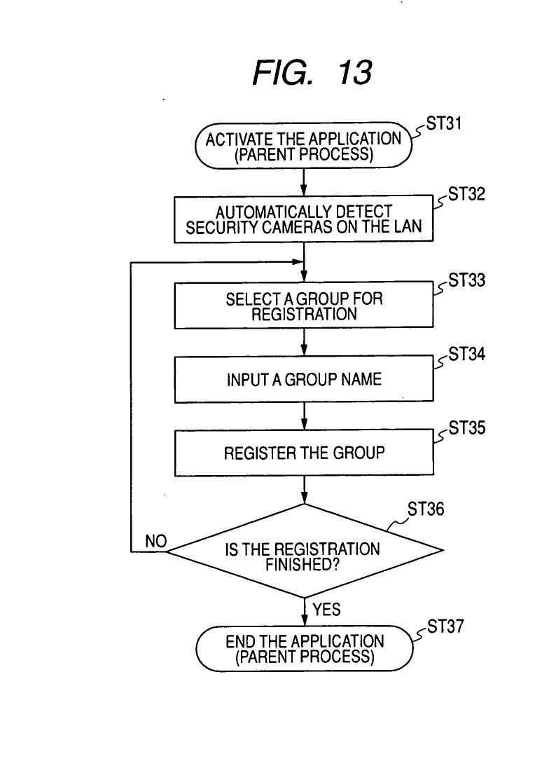

FIG. 13 shows a flow chart depicting the control operation in the registration of a group done by the control part 161 of the monitoring apparatus 104.

First, in Step ST31, the control part 161 activates the application (the parent process 182), and goes to Step ST32. In Step ST32, the control part 161 automatically detects security cameras 102 on the LAN (within the same network segment) to which the monitoring apparatus 104 is connected. Moreover, in Step ST32, the operator additionally registers a security camera 102 on the Internet 101 as a candidate destination as necessary.

Subsequently, when the operator selects a predetermined number of the security cameras 102 that configure a group to register from security cameras 102 displayed in the target camera section 202 on the GUI screen 200 in Step ST33 and the operator further enters its group name in Step ST34, the control part 161 registers the group in Step ST35.

Subsequently, in Step ST36, the control part 161 determines whether the registration is finished. When the operator continues the registration, the control part 161 determines that the registration is not finished, returns to Step ST33, and goes to control the registration of the next group. In contrast to this, the control part 161 determines that the registration is finished when the operator finishes the registration. In Step ST37, the control part 161 finishes the application (the parent process), and ends the control operation of registering the group.

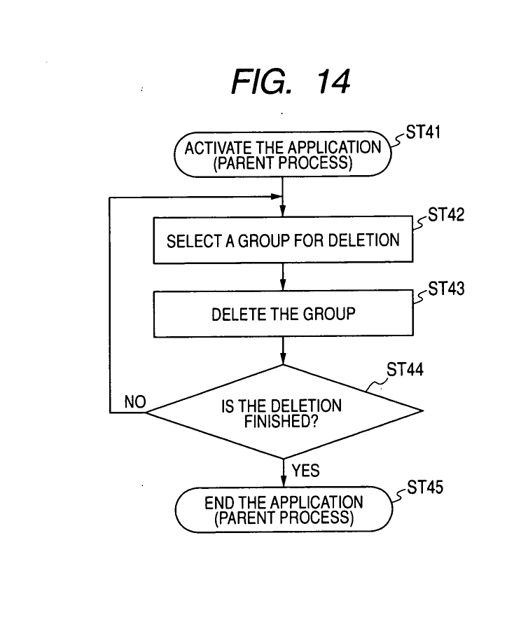

The group thus registered in the monitoring apparatus 104 can be deleted by operator's manipulation. FIG. 14 shows a flow chart depicting the control operation in the deletion of a group done by the control part 161 of the monitoring apparatus 104.

First, in Step ST41, the control part 161 activates the application (the parent process 182), and goes to Step ST42. In Step ST42, when the operator selects a group to delete, in Step ST43, the control part 161 deletes the selected group.

Subsequently, in Step ST44, the control part 161 determines whether the deletion is finished. When the operator continues the deletion, the control part 161 determines that the deletion is not finished, returns to Step ST42, and goes to control of deletion of the next group. In contrast to this, the control part 161 determines that the deletion is finished when the operator finishes the deletion. In Step ST45, the control part 161 finishes the application (the parent process), and ends the control operation of deleting the group.

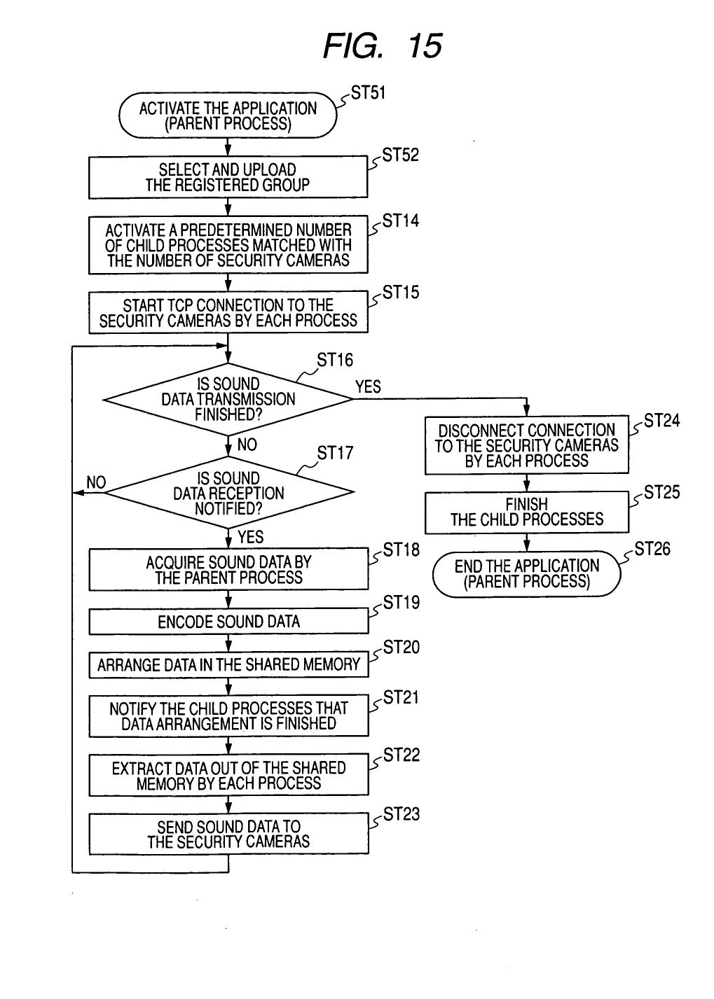

FIG. 15 shows a flow chart depicting the control operation of broadcast transmission done by the control part 161 of the monitoring apparatus 104. In the control operation, in selecting a predetermined number of security cameras 102 as destination security cameras 102, the operator selects a predetermined number of the groups registered above.

First, in Step ST51, the control part 161 activates the application (the parent process 182), and goes to Step ST52. In Step ST52, when the operator selects and uploads the registered group, the control part 161 goes to Step ST14. Moreover, the control operation after Step ST14 is the same as that in the flow chart shown in FIG. 12, omitting the descriptions.

As discussed above, in the configuration that allows the choice of the registered group in selecting a predetermined number of security cameras 102 as a destination, the operator can omit the operation of separately selecting security cameras 102 as a destination, and can quickly switch a group of the destination security cameras depending on the situations.

The monitoring apparatus 104 can similarly connect security cameras 102 in any places as long as the conditions allow network connections. In the application of the monitoring apparatus 104, it is difficult to determine the relation between positions of the security cameras 102 because the cameras look the same. As discussed above, the groups are registered to allow the operator to select a group of security cameras depending on arranged positions and environments for use, which leads to improved operator manipulations. In addition, as described above, a group name can be given when a group is registered, and the operator can distinguish between groups in intuition.

Moreover, in the embodiment, such an example is described in which a network apparatus to send sound data is the monitoring apparatus 104 and a network apparatus to receive sound data is the security camera 102, but a network apparatus to send or receive sound data is not restricted to those in the embodiment. For example, the network apparatus to receive sound data may be those having a function of simply outputting sounds configured of sound data.

In addition, in the embodiment, such a unit is described as the sound data sending part 180 which activates a plurality of processes (the parent process 182 and the child processes 183) in the broadcast transmission of sound data to a predetermined number of security cameras 102. However, such a configuration may be considered in which only the parent process 182 is activated, and the parent process establishes the connection to each of the security cameras 102 for sending sound data in a time division manner. Also in this case, it is unnecessary for the operator to repeat one to one communication by the number of the security cameras 102, which leads to a reduction in operator's operational efforts.

For example, the embodiment of the invention can be adapted to a security camera system in which a security camera having a sound output function is connected to a monitoring apparatus over a network.

It should be understood by those skilled in the art that various modifications, combinations, sub-combinations and alterations may occur depending on design requirements and other factors insofar as they are within the scope of the appended claims or the equivalents thereof.

What is claimed is:

1. A network apparatus that sends sound data to another network apparatus connected over a network, the network apparatus comprising:
a destination selecting part configured to select a predetermined number of network apparatuses as a destination network apparatus from network apparatuses connected to the network; and
a sound data sending part configured to broadcast sound data to the predetermined number of the network apparatuses selected in the destination selecting part.

2. The network apparatus according to claim 1, further comprising a network apparatus detecting part configured to automatically detect a network apparatus connected to the network.

3. The network apparatus according to claim 1,
wherein the sound data sending part has:
a shared memory in which the sound data is arranged; and
a sending means for extracting the sound data from the shared memory and for sending the sound data to the corresponding network apparatus, the sending means being provided by the predetermined number.

4. The network apparatus according to claim 1, further comprising a group registration part configured to register a group configured of given network apparatuses selected from network apparatuses connected to the network,
wherein the destination selecting part selects a predetermined number of groups registered in the group registration part to select the predetermined number of the network apparatuses.

5. A sound data transmission method of a network apparatus that sends sound data to another network apparatus connected over a network, the sound data transmission method comprising the steps of:
acquiring sound data from a sound source device;
compressing and encoding sound data acquired in the sound data acquiring step;
arranging sound data compressed and encoded in the compressing and encoding step in a shared memory; and
extracting the sound data from the shared memory and broadcasting the sound data to a predetermined number of the other network apparatuses.

6. A sound data transmission program that allows a computer to function as:
a sound data acquiring means for acquiring sound data from sound source device;
an encoding means for compressing and encoding sound data acquired in the sound data acquiring means;
a sound data arranging means for arranging a sound data compressed and encoded in the encoding means in a shared memory; and
a sound data sending means for extracting the sound data from the shared memory and for broadcasting the sound data to a predetermined number of network apparatuses.

7. A monitoring apparatus that is connected to a security camera having a sound output function over a network, the monitoring apparatus comprising:
a destination selecting means for selecting a predetermined number of the security cameras as a destination from security cameras connected to the network; and
a sound data sending part configured to broadcast sound data to the predetermined number of the security cameras selected in the destination selecting means.

8. A security camera system comprising:
a security camera connected to a monitoring apparatus over a network,
wherein the security camera has:
a sound data receiving part configured to receive sound data sent from the monitoring apparatus; and
a sound output part configured to output sounds configured of sound data received in the sound data receiving part, and
the monitoring apparatus has:
a destination selecting means for selecting a predetermined number of the security cameras as a destination from security cameras connected to the network; and
a sound data sending part configured to broadcast sound data to the predetermined number of the security cameras selected in the destination selecting means.

9. A monitoring apparatus that is connected to a security camera having a sound output function over a network, the monitoring apparatus comprising:
a destination selecting unit configured to select a predetermined number of the security cameras as a destination from security cameras connected to the network; and
a sound data sending part configured to broadcast sound data to the predetermined number of the security cameras selected in the destination selecting unit.

10. A security camera system comprising:
a security camera connected to a monitoring apparatus over a network,
wherein the security camera has:
a sound data receiving part configured to receive sound data sent from the monitoring apparatus; and
a sound output part configured to output sounds configured of sound data received in the sound data receiving part, and
the monitoring apparatus has:
a destination selecting unit configured to select a predetermined number of the security cameras as a destination from security cameras connected to the network; and
a sound data sending part configured to broadcast sound data to the predetermined number of the security cameras selected in the destination selecting means.
